(19) United States
(12) Patent Application Publication
(10) Pub. No.: US 2009/0228831 A1
(43) Pub. Date: Sep. 10, 2009

(54) CUSTOMIZATION OF USER INTERFACE ELEMENTS

(76) Inventors: ANDREAS WENDKER, Mountain View, CA (US); Maxwell O. Drukman, San Francisco, CA (US)

Correspondence Address: APPLE INC./BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/397,245

(22) Filed: Mar. 3, 2009

Related U.S. Application Data
(60) Provisional application No. 61/033,745, filed on Mar. 4, 2008.

(51) Int. Cl. G06F 3/048

(52) U.S. Cl. 715/808; 715/810

(57) ABSTRACT

Systems and methods are provided for manipulating a user interface. In certain embodiments, the user interface includes a window having one or more pop-up menus. Each pop-up menu includes a set of items that can be selected by a user. Upon selection of one or more of the items in a pop-up menu, in certain embodiments the user can drag the selected items to a target area in the user interface window. If there is a second pop-up menu at the target area, the selected items are transferred from the first pop-up menu to the second pop-up menu. If there is no second pop-up menu at the target area, a new pop-up menu is created that includes the selected items.

The present application claims priority to U.S. Provisional Application No. 61/033,745, filed Mar. 4, 2008, and entitled “CUSTOMIZATION OF USER INTERFACE ELEMENTS .”

### BACKGROUND

### Description of the Related Technology

A computer program often includes a user interface by which users can interact with the program. The user interface can provide graphical, textual, or other tools for providing inputs to the program and for receiving outputs from the program. Typical user interfaces can include one or more elements or controls, such as menus, windows, buttons, text boxes, labels, and the like. Input devices for interacting with the user interface can include a mouse, keyboard, touch screen, remote control, game controller, or the like.

One user interface element common to many user interfaces is the menu control. The menu control can be an icon, button, drop-down list control, or the like. In some implementations, when the menu control is selected (e.g., by clicking with a mouse or by typing a shortcut key sequence), a menu including a list of items is displayed. This menu can appear to pop up over underlying display elements. These menus are therefore often referred to as “pop-up menus.”

Many user interfaces have a large number of menus that can overwhelm a user. Many interfaces also have menus that many users rarely use. User productivity can be adversely affected by such user interfaces.

### BRIEF DESCRIPTION OF THE DRAWINGS

FIG. 1 is a flowchart diagram illustrating an embodiment of a process for manipulating pop-up menus; FIGS. 2 through 9 illustrate example user interfaces for manipulating pop-up menus according to certain embodiments of the process of FIG. 1;

FIG. 10 is a block diagram of illustrating an example computer system for implementing certain embodiments of the process of FIG. 1; and

FIG. 11A is an elevation-view diagram illustrating an example mobile device that can be used with certain embodiments of the systems and methods described herein;

FIG. 11B is an elevation-view diagram illustrating an example of a configurable top-level graphical user interface for the mobile device of FIG. 11A; and

FIG. 12 is a block diagram illustrating an example implementation of the mobile device of FIG. 11A.

### DETAILED DESCRIPTION OF SOME EMBODIMENTS

Having several pop-up menus (or menu controls for accessing the pop-up menus) in a user interface window can clutter the window and confuse a user. In addition, some windows include pop-up menus or controls that are infrequently used. Certain users might therefore wish to customize the layout of menu controls and/or the content of the pop-up menus to reduce clutter or otherwise improve organization of the menus. However, currently available user interfaces provide no mechanisms for customizing menus within a user interface window.

Thus, in certain embodiments, systems and methods are provided for customizing menus that address some or all of the above-mentioned problems. In certain embodiments, these systems and methods can include the ability to move, delete, and create menu controls or pop-up menus. In addition, in certain embodiments, pop-up menus can be merged or items from pop-up menus can be moved to other pop-up menus.

For purposes of illustration, the systems and methods described herein are described primarily in the context of menu customization. However, in certain embodiments, user interface elements other than menus can also be customized using the systems and methods described herein. For example, buttons, text boxes, labels, combinations of the same, and the like can be customized in certain embodiments.

The features of these systems and methods will now be described with reference to the drawings summarized above. Throughout the drawings, reference numbers are re-used to indicate correspondence between referenced elements. The drawings, associated descriptions, and specific implementation are provided to illustrate embodiments of the invention and not to limit the scope of the inventions disclosed herein.

In addition, methods and processes described herein are not limited to any particular sequence, and the blocks or states relating thereto can be performed in other sequences that are appropriate. For example, described blocks or states may be performed in an order other than that specifically disclosed, or multiple blocks or states may be combined in a single block or state. Moreover, the various modules of the systems described herein can be implemented as software applications, modules, or components on one or more computers, such as servers. While the various modules are illustrated separately, they may share some or all of the same underlying logic or code.

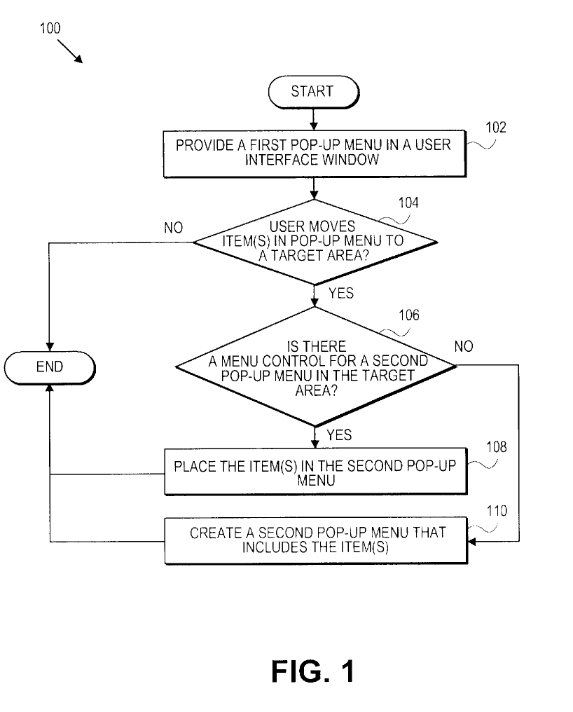

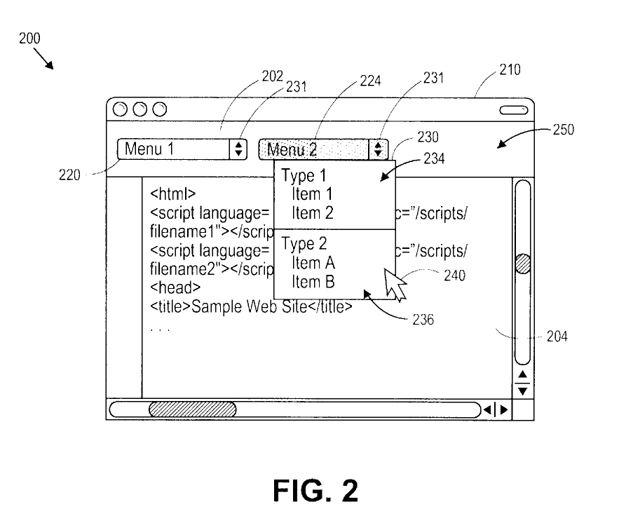

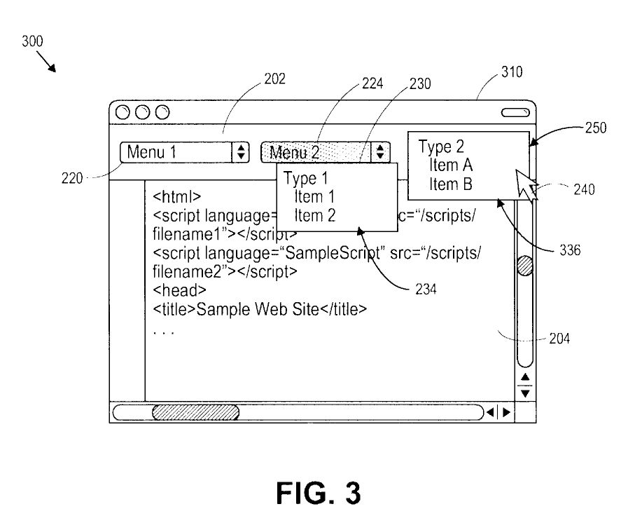

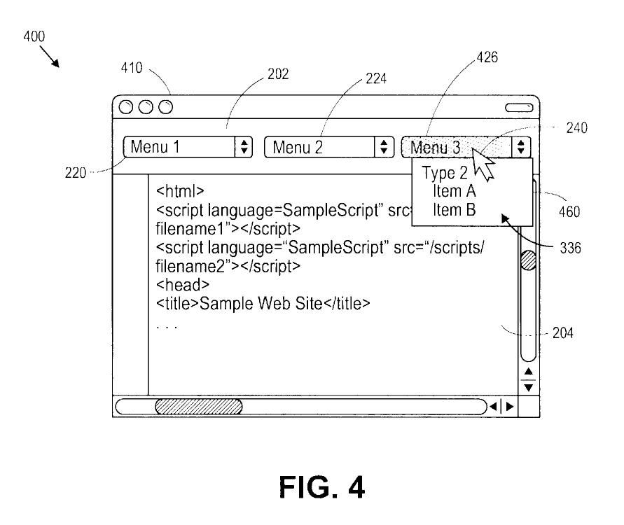

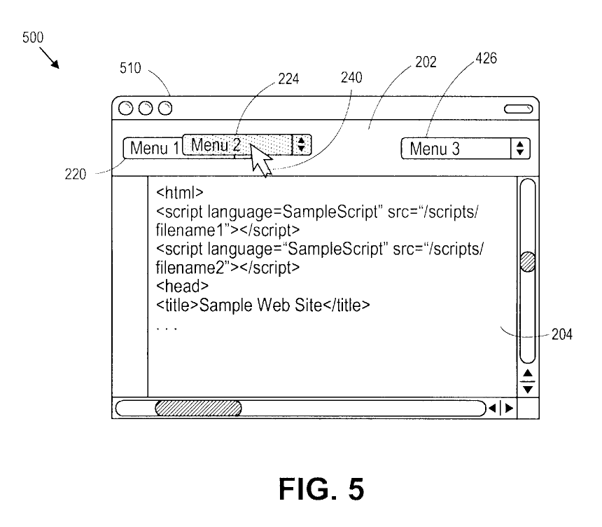

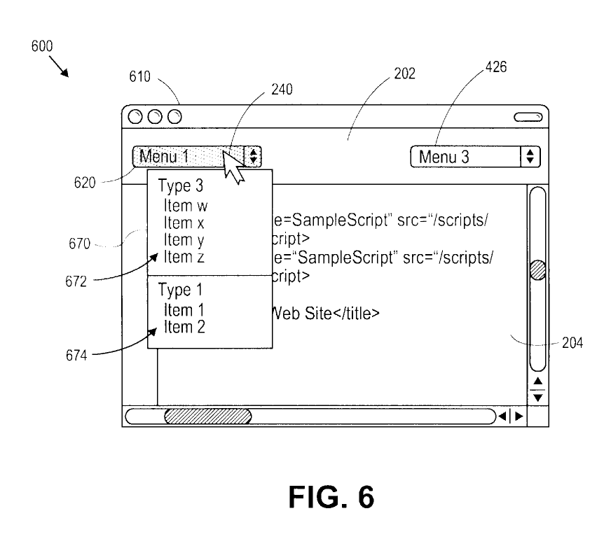

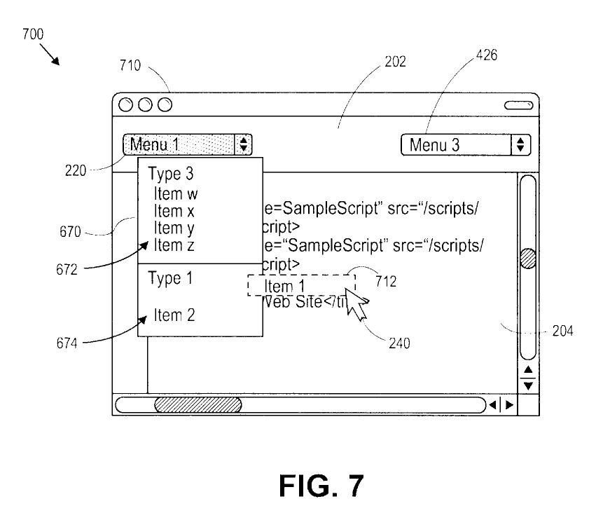

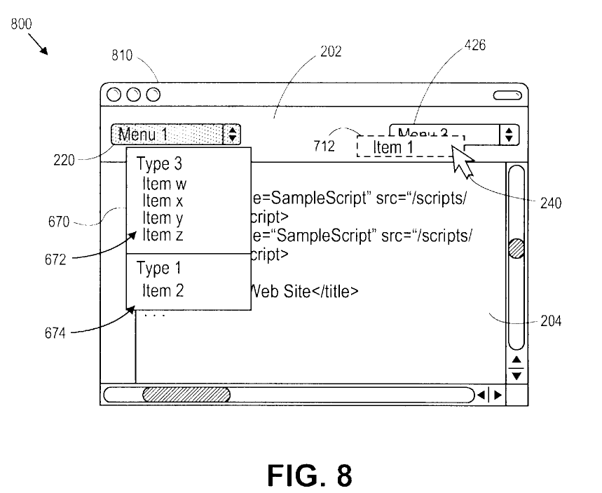

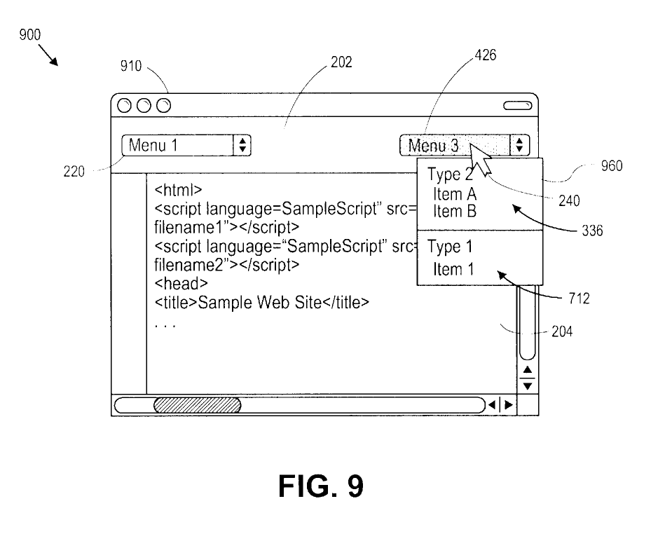

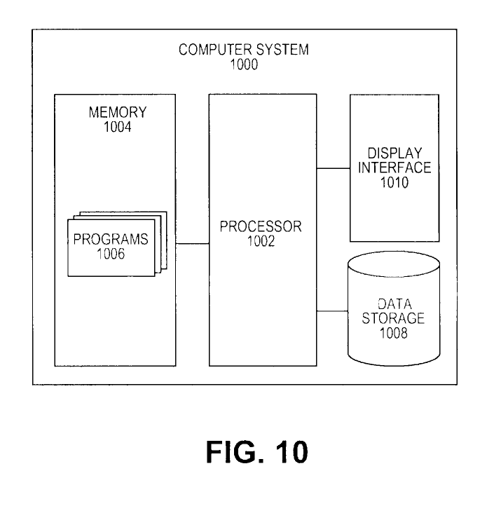

FIG. 1 illustrates certain embodiments of an example process 100 for manipulating user interfaces. In certain embodiments, process 100 can be used to manipulate menus in a user interface. Process 100 can be implemented in certain embodiments by a computer system such as the computer system described below with respect to FIG. 10. Advantageously, process 100 can provide a user with a greater degree of control over the contents and/or location of menus in a user interface.

At block 102, a first pop-up menu in a user interface window is provided. The first pop-up menu can be accessed, for example, by using an input device to select a menu control corresponding to the pop-up menu. The first pop-up menu can include one or more items or options that can be selected by a user. For example, in some computer systems, a file menu control, when selected, presents several items in the form of textual labels, such as a “Save” option for saving a file or an “Exit” option for closing a file. Example menu controls and pop-up menus are illustrated and described below with respect to FIGS. 2-9.

At block 104, it is determined whether a user moves one or more items in the first pop-up menu to a target area. The items can be moved by the user in certain embodiments by selecting the items with an input device such as a mouse and by “dragging” the items to the target area. The target area can be any location in the user interface such as a toolbar, any location within a window, on a desktop display, or anywhere else on a display. If it is determined that the user has not moved an item in the pop-up menu to the target area, then process 100 ends.

If, however, the user did move the items to the target area, it is determined at block 106 whether there is a menu control for a second pop-up menu in the target area. If there is a menu control in the target area, then at block 108 the selected items are placed in the second pop-up menu. The selected item from the first pop-up menu can be added to any items already in the second pop-up menu. Alternatively, in certain embodiments, the selected items placed into the second pop-up menu can replace any items that were in the second pop-up menu. If it is instead determined that there is no menu control for a second pop-up menu in the target area, then at block 110 a second pop-up menu and/or corresponding menu control is created that includes the selected items.

Advantageously, if a new pop-up menu is created at block 110, the selected items may be automatically removed from the first pop-up menu. Thus, the new pop-up menu can be intelligently aware of the contents of the first pop-up menu and vice versa. Thereafter process 100 ends.

In addition to the embodiments described, in certain alternative embodiments, process 100 can enable pop-up menus or menu controls to be moved to different areas in a user interface. Thus, for example, a user can swap the location of menus, move menus to different parts of a window, and so on. In addition, in some implementations, customization options other than dragging a pop-up menu or menu item using a mouse are provided.

FIGS. 2 through 9 illustrate example user interface windows. The example user interface windows in certain embodiments illustrate the same window at different stages over time as they are manipulated by a user. By way of overview, FIGS. 2-4 illustrate an example creation of a new menu control having a pop-up menu. The new menu control is created in certain embodiments by moving items or elements from one pop-up menu to a new target area in the window. FIGS. 5-6 illustrate examples of combining menu controls by moving one menu control onto another menu control. FIGS. 7-9 illustrate examples of moving one item from a pop-up menu to another menu control. Many other techniques and implementations for customizing the user interfaces shown can be used other than those shown. Thus, the examples shown are for illustrative purposes only and shall not be construed to limit the inventions disclosed herein.

Turning to FIG. 2, user interface 200 for an example application is shown. The example application having user interface 200 shown is a software development application, which may be part of an integrated development environment (IDE) or software development kit (SDK). Certain embodiments described herein are not limited to applications for developing software; however, customization of menus can be helpful in software development environments.

In the depicted embodiment, user interface 200 includes window 210 having toolbar 202 and window body 204. One toolbar 202 is shown, although many toolbars can be used in certain implementations. Toolbar 202 is located at the top or near the top of window 210. In certain implementations, toolbar 202 can be in any other location within the window or outside of the window, for example, as a floating toolbar, which can be in its own window. Window body 204 includes an area for writing software. Window body 204 can have different functions in other applications.

Example toolbar 202 include two menus controls 220, 224. Menu controls 220, 224 each include a textual label (“menu 1” and “menu 2,” respectively) as well as arrows 231 to navigate within menu control 220, 224. In other embodiments, menu controls 220, 224 may not have textual labels but can rather have icons or graphics, a textbox for entering a search term, combinations of the same, and the like. Menu control 220 is shown in FIGS. 2 through 4 without a corresponding pop-up menu because menu control 220 is not currently selected. However, selection of menu control 220 can cause a pop-up menu to appear.

In contrast, menu control 224 is currently selected, as illustrated by a darkened color of menu control 224. Because menu control 224 is selected, pop-up menu 230 is displayed beneath menu control 224. The position of pop-up menu 230 can be configured to be any position within or outside of window 210 in various implementations and need not be beneath menu control 224. Pop-up menu 230 includes first and second sets of items, 234 and 236. Each set of items 234, 236 includes items that are related by type. For example, first set of items 234 includes items 1 and 2 that are of type 1, and second set of items 236 includes items A and B which are of type 2. Other pop-up menus may include items that are not grouped by types in certain implementations.

In certain embodiments, the textual labels (or icons) of a menu control 220, 224 can correspond to the types of items 234, 236 provided in corresponding pop-up menus 230. Examples of textual labels are now provided. In these examples, the user interface 200 is a software development program. One example menu control 224 in the software development program might have a textual label of “Device” corresponding to a device for which software is being developed (e.g., replace “Menu 2” with “Device”). A type of items 234 can include, for instance, “Platform” (e.g., replace “Type 1” with “Platform”). Thus, an example pop-up menu 230 for the menu control “Device” is shown as follows, using various example items 234:
Platform
   Device—iPhone version 1.0
   Device—iPhone version 1.2
   Simulator—iPhone version 1.0
   Simulator—iPhone version 1.2

If multiple types of items 234 are shown in the pop-up menu 230, the textual label of the menu control 224 can reflect each type. For example, if a second type (Type 2) in the pop-up menu 230 is “Build Configuration,” the textual label of the menu control 220 might be “Device and Configuration.” A corresponding pop-up menu might be as follows:
Platform
   Device—iPhone version 1.0
   Device—iPhone version 1.2
   Simulator—iPhone version 1.0
   Simulator—iPhone version 1.2
Build Configuration
   Release
   Debug

However, in one embodiment, if one of the types has only one item, the name of the type may be omitted from the textual label of the menu control 224 to reduce clutter in the user interface 200. Thus, the following example pop-up menu might have the textual label “Device and Configuration” rather than “Device, Configuration, and Architecture”:
Platform
   Device—iPhone version 1.0
   Device—iPhone version 1.2
   Simulator—iPhone version 1.0
   Simulator—iPhone version 1.2
Build Configuration
   Release
   Debug
Architecture
   ARM 6.0

In another embodiment, if only one type exists in a pop-up menu 230, the textual label corresponding to that type may be used by menu control 220.

Items in pop-up menus 230 can be moved to other locations in the user interface 220 to create new pop-up menus or be added to existing menu controls. Specific examples of manipulating pop-up menus and menu controls are described below with respect to FIGS. 3-9. Advantageously, manipulating menus using these techniques can cause the textual labels of the menu controls 220, 224 to change, as described below. As a result, user interface 200 can have a more streamlined appearance.

Referring again to FIG. 2, cursor 240 is shown in the form of an arrow. Cursor 240 is positioned over the second set of items 236 in pop-up menu 230. Cursor 240 can be, for example, the graphical pointer of a pointing device such as a mouse or other user interface device. In certain embodiments, cursor 240 can be used to select any item or set of items. As shown in the depicted example, cursor 240 is being used to select second set of items 236. Cursor 240 can be moved to another area in or outside window 210. Upon selecting set of items 236 and moving cursor 240 to target area 250 in window 210, set of items 236 can leave pop-up menu 230 and move to target area 250.

Target area 250 can be a user-selected location for placing items, sets of items, menus, and the like. In the depicted embodiment, target area 250 is on toolbar 202. Other options for the location of the target area are described below with respect to FIGS. 5-9.

A second set of items 236, when selected by cursor 240 and moved toward the target area, becomes a set of selected items 336 as shown in FIG. 3. In window 310 of FIG. 3, a selected set of items 336 is shown moved to target area 250. Cursor 240 can be used to deselect set of items 336 at target area 250. In certain embodiments, deselecting selected set of items 336 at target area 250 can cause selected set of items 336 to be dropped onto or otherwise placed onto target area 250.

Once selected set of items 336 are dropped onto target area 250, a new menu control can be created. FIG. 4 illustrates window 410 that shows new menu control 426 created in response to dropping or otherwise placing selected set of items 336 onto target area 250. Menu control 426 includes pop-up menu 460 which appears when menu control 426 is selected, for example, by cursor 240. Pop-up menu 460 includes set of items 336.

Thus, moving items 336 from menu control 224 to another area in the user interface (target area 250) can advantageously facilitate creation of another menu control 426. In addition, items 336 can be removed from menu control 224 upon creation of new menu control 426. In certain alternative embodiments, items 336 can be left in original menu control 224 when new menu control 426 is created.

In certain embodiments, creating a new menu control 426 from a previous menu control 224 can cause the textual labels of the previous menu control 224 to change. To illustrate certain embodiments of changing textual labels using the software development example of FIG. 2 above, the old menu control 224 may have a textual label of “Device and Configuration” with a pop-up menu as follows:
Platform
   Device—iPhone version 1.0
   Device—iPhone version 1.2
   Simulator—iPhone version 1.0
   Simulator—iPhone version 1.2
Build Configuration
   Release
   Debug

If the items corresponding to the “Build Configuration” type (e.g., “Release” and “Debug”) are removed from the pop-up menu 230 to create a new menu control 426, the old menu control's 224 textual label might be modified to “Device,” and pop-up menu 230 might include:
Platform
   Device—iPhone version 1.0
   Device—iPhone version 1.2
   Simulator—iPhone version 1.0
   Simulator—iPhone version 1.2

Likewise, the new menu control 426 might have a textual label of “Configuration” created and new pop-up menu 460 as follows:
Build Configuration
   Release
   Debug

FIGS. 5 and 6 illustrate another embodiment of manipulating a user interface 500. Specifically, FIGS. 5 and 6 illustrate an example embodiment of combining two menus or menu controls. Advantageously, combining menus or menu controls can enable a user to streamline the appearance of toolbar 202 or application.

In FIG. 5, user interface 500 includes window 510. Window 510 further includes certain of the elements described above with respect to FIGS. 2 through 4, such as toolbar 202, window body 204, and menu controls 220, 224, and 426. Menu control 224 is shown in the depicted embodiment as being selected by cursor 240. In addition, menu control 224 has been dragged or otherwise moved to target area using cursor 240. The target area in the depicted embodiment is menu control 220.

FIG. 6 illustrates user interface 600, which illustrates the effects of certain embodiments of moving menu control 224 to menu control 220. When deselected over menu control 220, menu control 224 is dropped or otherwise placed onto menu control 220. As a result, the two menu controls 220, 224 are combined into one menu control 620. Pop-up menu 670 of menu control 620 can be modified to include set of items 674 that were previously in menu control 224. Pop-up menu 670 can also include set of items 672 that already existed in menu control 220, although these items were not shown previously. Although pop-up menu 670 includes old set of items 672 and new set of items 674, in certain embodiments, new set of items 674 replaces old set of items 672 upon moving or dropping menu control 224 onto menu control 220.

Thus, user interfaces 500 and 600 illustrate how a user can combine menus. Advantageously, combining menus can reduce clutter within a user interface window, enabling the user to more easily find options in the user interface.

In certain embodiments, combining the menu control 224 with the menu control 220 can cause the textual label of the menu control 220 to change. Thus, returning to our previous example, the old menu control 220 might have previously had the label “Device” and the following pop-up menu:
Platform
   Device—iPhone version 1.0
   Device—iPhone version 1.2
   Simulator—iPhone version 1.0
   Simulator—iPhone version 1.2

Likewise, the old menu control 224 might have had the textual label “Configuration” along with the following items in its pop-up menu:
Build Configuration
   Release
   Debug

Adding the items in the pop-up menu 224 to the pop-up menu 220 can result in new menu control 620 having a textual label of “Device and Configuration,” with items in pop-up menu 670 as follows:
Platform
   Device—iPhone version 1.0
   Device—iPhone version 1.2
   Simulator—iPhone version 1.0
   Simulator—iPhone version 1.2
Build Configuration
   Release
   Debug

FIGS. 7 through 9 illustrate yet another embodiment for manipulating a user interface. Similar to the user interfaces described above, FIGS. 7 through 9 illustrate user interface 700 having windows 710, 810, and 910, respectively, that change based on user customizations. In particular, FIGS. 7 through 9 illustrate an example embodiment of removing an item from a pop-up menu and transferring that item to another pop-up menu.

In FIG. 7, window 710 is shown having certain components of the windows described above with respect to FIGS. 2 through 6. For example, window 710 includes toolbar 202 and menu controls 220, 426 on the toolbar. In the depicted embodiment, menu control 220 is selected, as indicated by a darkened color. Because menu control 220 is selected, pop-up menu 670 is displayed.

Selected item 712 from set of items 674 has been selected by cursor 240 and has been removed from set of items 674. In window 810 of FIG. 8, selected item 712 has been moved by cursor 240 to a target area. The target area in the depicted embodiment is menu control 426. In window 910 of FIG. 9, selected item 712 has been dropped or otherwise placed on menu control 426. As a result, item 712 has become a part of pop-up menu 960. Pop-up menu 960 includes set of items 336 from pop-up 460 as well as items 712. Advantageously, moving item 712 to another pop-up menu in certain embodiments causes item 712 to be removed from the pop-up menu it originated from (e.g., pop-up menu 670).

While one item 712 has been shown being moved from a pop-up menu to another, in other embodiments multiple items (including non-consecutive items) can be moved from one pop-up menu to another.

FIG. 10 depicts certain embodiments of a computer system 1000. Computer system 1000 of various embodiments facilitates customizing user interfaces. In one embodiment, computer system 1000 can be a computer system of a user of any of the user interfaces described above.

Illustrative computer systems 1000 include general purpose (e.g., PCs) and special purpose (e.g., graphics workstations) computer systems, which may include one or more servers, databases, and the like. In addition, computer system 1000 can be a handheld or portable device, such as a laptop, personal digital assistant (PDA), cell phone, smart phone, or the like. More generally, any processor-based system may be used as computer system 1000.

Computer system 1000 of certain embodiments includes processor 1002 for processing one or more software programs 1006 stored in memory 1004, for accessing data stored in hard data storage 1008, and for communicating with display interface 1010. Display interface 1010 provides an interface to a computer display or displays, such as one or more monitors or screens. In certain embodiments, one or more programs 1006 can use display interface 1010 to effectuate any of the customization features to any user interface described above.

In an embodiment, computer system 1000 further includes, by way of example, one or more processors, program logic, or other substrate configurations representing data and instructions, which operate as described herein. In other embodiments, the processor can comprise controller circuitry, processor circuitry, processors, general purpose single-chip or multi-chip microprocessors, digital signal processors, embedded microprocessors, microcontrollers, graphics processors, and the like.

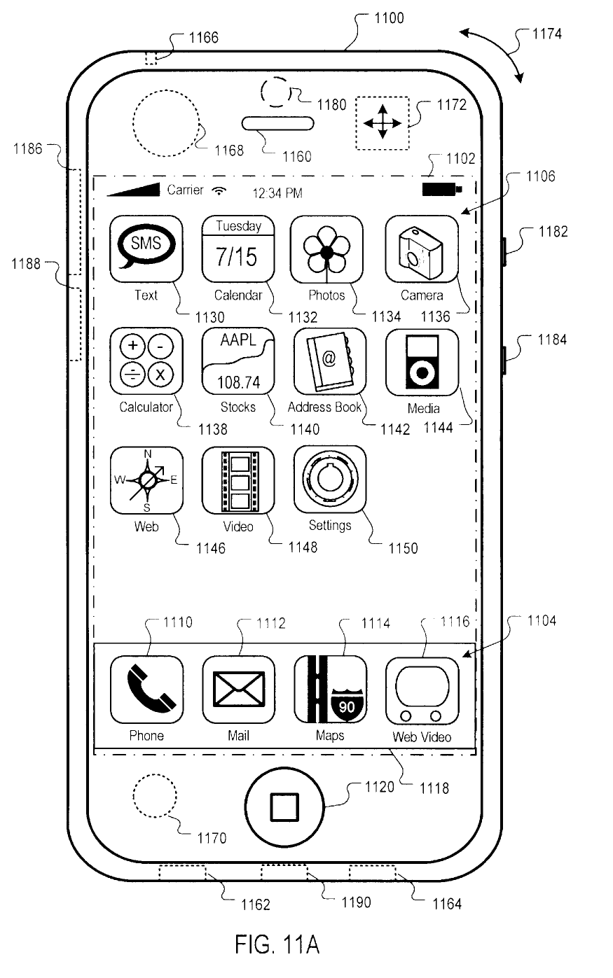

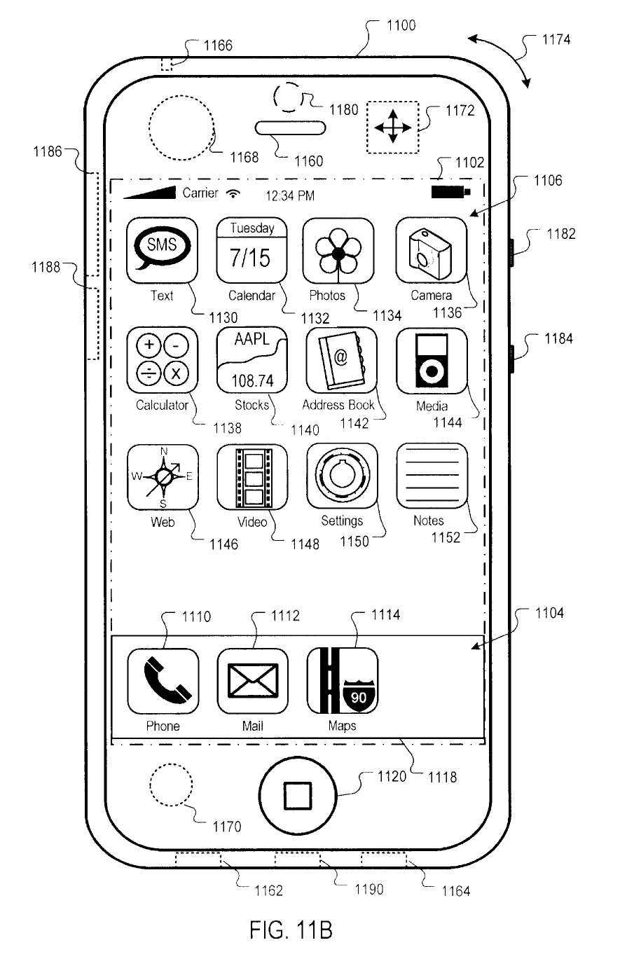

FIG. 11A illustrates an example mobile device 1100. The mobile device 1100 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

### Mobile Device Overview

In some implementations, the mobile device 1100 includes a touch-sensitive display 1102. The touch-sensitive display 1102 can be implemented with liquid crystal display (LCD) technology, light emitting polymer display (LPD) technology, or some other display technology. The touch-sensitive display 1102 can be sensitive to haptic and/or tactile contact with a user.

In some implementations, the touch-sensitive display 1102 can include a multi-touch-sensitive display 1102. A multi-touch-sensitive display 1102 can, for example, process multiple simultaneous touch points, including processing data related to the pressure, degree, and/or position of each touch point. Such processing facilitates gestures and interactions with multiple fingers, chording, and other interactions. Other touch-sensitive display technologies can also be used, e.g., a display in which contact is made using a stylus or other pointing device. Some examples of multi-touch-sensitive display technology are described in U.S. Pat. Nos. 6,323,846, 6,570,557, 6,677,932, and 6,888,536, each of which is incorporated by reference herein in its entirety.

In some implementations, the mobile device 1100 can display one or more graphical user interfaces on the touch-sensitive display 1102 for providing the user access to various system objects and for conveying information to the user. In some implementations, the graphical user interface can include one or more display objects 1104, 1106. In the example shown, the display objects 1104, 1106, are graphic representations of system objects. Some examples of system objects include device functions, applications, windows, files, alerts, events, or other identifiable system objects.

### Example Mobile Device Functionality

In some implementations, the mobile device 1100 can implement multiple device functionalities, such as a telephony device, as indicated by a Phone object 1110; an e-mail device, as indicated by the Mail object 1112; a map devices, as indicated by the Maps object 1114; a Wi-Fi base station device (not shown); and a network video transmission and display device, as indicated by the Web Video object 1116. In some implementations, particular display objects 1104, e.g., the Phone object 1110, the Mail object 1112, the Maps object 1114, and the Web Video object 1116, can be displayed in a menu bar 1118. In some implementations, device functionalities can be accessed from a top-level graphical user interface, such as the graphical user interface illustrated in FIG. 11A. Touching one of the objects 1110, 1112, 1114, or 1116 can, for example, invoke a corresponding functionality.

In some implementations, the mobile device 1100 can implement a network distribution functionality. For example, the functionality can enable the user to take the mobile device 1100 and provide access to its associated network while traveling. In particular, the mobile device 1100 can extend Internet access (e.g., Wi-Fi) to other wireless devices in the vicinity. For example, mobile device 1100 can be configured as a base station for one or more devices. As such, mobile device 1100 can grant or deny network access to other wireless devices.

In some implementations, upon invocation of a device functionality, the graphical user interface of the mobile device 1100 changes, or is augmented or replaced with another user interface or user interface elements, to facilitate user access to particular functions associated with the corresponding device functionality. For example, in response to a user touching the Phone object 1110, the graphical user interface of the touch-sensitive display 1102 may present display objects related to various phone functions; likewise, touching of the Mail object 1112 may cause the graphical user interface to present display objects related to various e-mail functions; touching the Maps object 1114 may cause the graphical user interface to present display objects related to various maps functions; and touching the Web Video object 1116 may cause the graphical user interface to present display objects related to various web video functions.

In some implementations, the top-level graphical user interface environment or state of FIG. 11A can be restored by pressing a button 1120 located near the bottom of the mobile device 1100. In some implementations, each corresponding device functionality may have corresponding “home” display objects displayed on the touch-sensitive display 1102, and the graphical user interface environment of FIG. 11A can be restored by pressing the “home” display object.

In some implementations, the top-level graphical user interface can include additional display objects 1106, such as a short messaging service (SMS) object 1130, a Calendar object 1132, a Photos object 1134, a Camera object 1136, a Calculator object 1138, a Stocks object 1140, a Address Book object 1142, a Media object 1144, a Web object 1146, a Video object 1148, a Settings object 1150, and a Notes object (not shown). Touching the SMS display object 1130 can, for example, invoke an SMS messaging environment and supporting functionality; likewise, each selection of a display object 1132, 1134, 1136, 1138, 1140, 1142, 1144, 1146, 1148, and 1150 can invoke a corresponding object environment and functionality.

Additional and/or different display objects can also be displayed in the graphical user interface of FIG. 11A. For example, if the device 1100 is functioning as a base station for other devices, one or more “connection” objects may appear in the graphical user interface to indicate the connection. In some implementations, the display objects 1106 can be configured by a user, e.g., a user may specify which display objects 1106 are displayed, and/or may download additional applications or other software that provides other functionalities and corresponding display objects.

In some implementations, the mobile device 1100 can include one or more input/output (I/O) devices and/or sensor devices. For example, a speaker 1160 and a microphone 1162 can be included to facilitate voice-enabled functionalities, such as phone and voice mail functions. In some implementations, an up/down button 1184 for volume control of the speaker 1160 and the microphone 1162 can be included. The mobile device 1100 can also include an on/off button 1182 for a ring indicator of incoming phone calls. In some implementations, a loud speaker 1164 can be included to facilitate hands-free voice functionalities, such as speaker phone functions. An audio jack 1166 can also be included for use of headphones and/or a microphone.

In some implementations, a proximity sensor 1168 can be included to facilitate the detection of the user positioning the mobile device 1100 proximate to the user's ear and, in response, to disengage the touch-sensitive display 1102 to prevent accidental function invocations. In some implementations, the touch-sensitive display 1102 can be turned off to conserve additional power when the mobile device 1100 is proximate to the user's ear.

Other sensors can also be used. For example, in some implementations, an ambient light sensor 1170 can be utilized to facilitate adjusting the brightness of the touch-sensitive display 1102. In some implementations, an accelerometer 1172 can be utilized to detect movement of the mobile device 1100, as indicated by the directional arrow 1174. Accordingly, display objects and/or media can be presented according to a detected orientation, e.g., portrait or landscape. In some implementations, the mobile device 1100 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into the mobile device 1100 or provided as a separate device that can be coupled to the mobile device 1100 through an interface (e.g., port device 1190) to provide access to location-based services.

In some implementations, a port device 1190, e.g., a Universal Serial Bus (USB) port, or a docking port, or some other wired port connection, can be included. The port device 1190 can, for example, be utilized to establish a wired connection to other computing devices, such as other communication devices 1100, network access devices, a personal computer, a printer, a display screen, or other processing devices capable of receiving and/or transmitting data. In some implementations, the port device 1190 allows the mobile device 1100 to synchronize with a host device using one or more protocols, such as, for example, the TCP/IP, HTTP, UDP and any other known protocol.

The mobile device 1100 can also include a camera lens and sensor 1180. In some implementations, the camera lens and sensor 1180 can be located on the back surface of the mobile device 1100. The camera can capture still images and/or video.

The mobile device 1100 can also include one or more wireless communication subsystems, such as an 802.11b/g communication device 1186, and/or a Bluetooth™ communication device 1188. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

### Example Configurable Top-Level Graphical User Interface

FIG. 11B illustrates another example of configurable top-level graphical user interface of device 1100. The device 1100 can be configured to display a different set of display objects.

In some implementations, each of one or more system objects of device 1100 has a set of system object attributes associated with it; and one of the attributes determines whether a display object for the system object will be rendered in the top-level graphical user interface. This attribute can be set by the system automatically, or by a user through certain programs or system functionalities as described below. FIG. 11B shows an example of how the Notes object 1152 (not shown in FIG. 11A) is added to and the Web Video object 1116 is removed from the top graphical user interface of device 1100 (e.g. such as when the attributes of the Notes system object and the Web Video system object are modified).

### Example Mobile Device Architecture

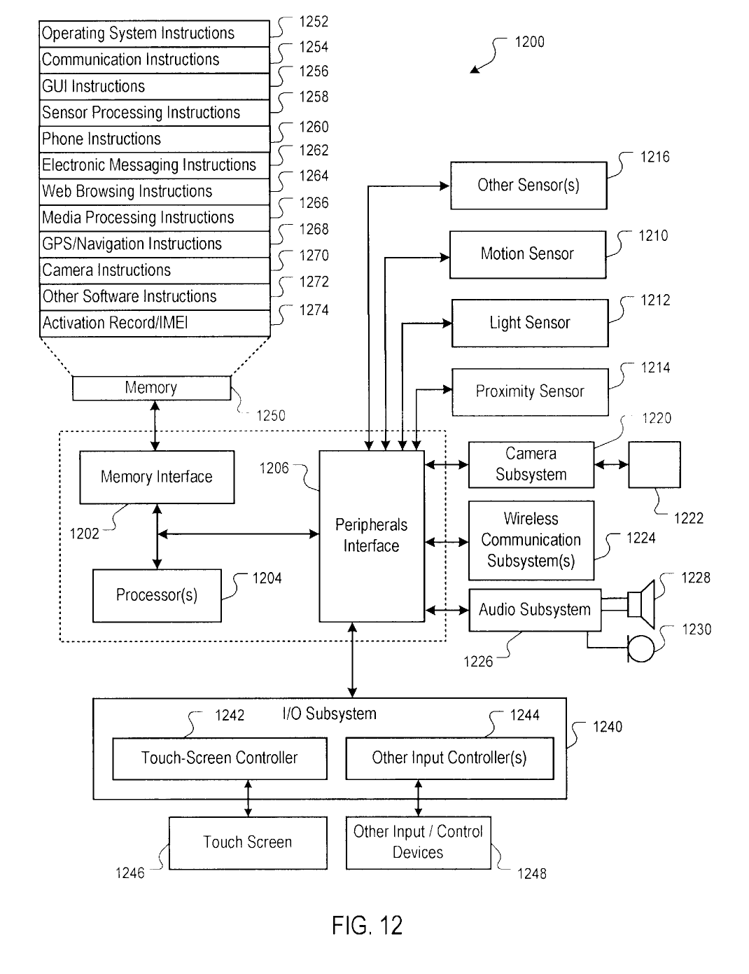

FIG. 12 is a block diagram 1200 of an example implementation of a mobile device (e.g., mobile device 1100). The mobile device can include a memory interface 1202, one or more data processors, image processors and/or central processing units 1204, and a peripherals interface 1206. The memory interface 1202, the one or more processors 1204 and/or the peripherals interface 1206 can be separate components or can be integrated in one or more integrated circuits. The various components in the mobile device can be coupled by one or more communication buses or signal lines.

Sensors, devices, and subsystems can be coupled to the peripherals interface 1206 to facilitate multiple functionalities. For example, a motion sensor 1210, a light sensor 1212, and a proximity sensor 1214 can be coupled to the peripherals interface 1206 to facilitate the orientation, lighting, and proximity functions described with respect to FIG. 11A. Other sensors 1216 can also be connected to the peripherals interface 1206, such as a positioning system (e.g., GPS receiver), a temperature sensor, a biometric sensor, or other sensing device, to facilitate related functionalities.

A camera subsystem 1220 and an optical sensor 1222, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 1224, which can include radio frequency receivers and transmitters and/or optical (e.g., infrared) receivers and transmitters. The specific design and implementation of the communication subsystem 1224 can depend on the communication network(s) over which the mobile device is intended to operate. For example, a mobile device can include communication subsystems 1224 designed to operate over a GSM network, a GPRS network, an EDGE network, a Wi-Fi or WiMax network, and a Bluetooth™ network. In particular, the wireless communication subsystems 1224 may include hosting protocols such that the mobile device may be configured as a base station for other wireless devices.

An audio subsystem 1226 can be coupled to a speaker 1228 and a microphone 1230 to facilitate voice-enabled functions, such as voice recognition, voice replication, digital recording, and telephony functions.

The I/O subsystem 1240 can include a touch screen controller 1242 and/or other input controller(s) 1244. The touch-screen controller 1242 can be coupled to a touch screen 1246. The touch screen 1246 and touch screen controller 1242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 1246.

The other input controller(s) 1244 can be coupled to other input/control devices 1248, such as one or more buttons, rocker switches, thumb-wheel, infrared port, USB port, and/or a pointer device such as a stylus. The one or more buttons (not shown) can include an up/down button for volume control of the speaker 1228 and/or the microphone 1230.

In one implementation, a pressing of the button for a first duration may disengage a lock of the touch screen 1246; and a pressing of the button for a second duration that is longer than the first duration may turn power to the mobile device on or off. The user may be able to customize a functionality of one or more of the buttons. The touch screen 1246 can, for example, also be used to implement virtual or soft buttons and/or a keyboard.

In some implementations, the mobile device can present recorded audio and/or video files, such as MP3, AAC, and MPEG files. In some implementations, the mobile device can include the functionality of an MP3 player, such as an iPod™. The mobile device may, therefore, include a 32-pin connector that is compatible with the iPod™. Other input/output and control devices can also be used.

The memory interface 1202 can be coupled to memory 1250. The memory 1250 can include high-speed random access memory and/or non-volatile memory, such as one or more magnetic disk storage devices, one or more optical storage devices, and/or flash memory (e.g., NAND, NOR). The memory 1250 can store an operating system 1252, such as Darwin, RTXC, LINUX, UNIX, OS X, WINDOWS, or an embedded operating system such as VxWorks. The operating system 1252 may include instructions for handling basic system services and for performing hardware dependent tasks. In some implementations, the operating system 1252 can be a kernel (e.g., UNIX kernel).

The memory 1250 may also store communication instructions 1254 to facilitate communicating with one or more additional devices, one or more computers and/or one or more servers. The memory 1250 may include graphical user interface instructions 1256 to facilitate graphic user interface processing; sensor processing instructions 1258 to facilitate sensor-related processing and functions; phone instructions 1260 to facilitate phone-related processes and functions; electronic messaging instructions 1262 to facilitate electronic-messaging related processes and functions; web browsing instructions 1264 to facilitate web browsing-related processes and functions; media processing instructions 1266 to facilitate media processing-related processes and functions; GPS/Navigation instructions 1268 to facilitate GPS and navigation-related processes and instructions; camera instructions 1270 to facilitate camera-related processes and functions; and/or other software instructions 1272 to facilitate other processes and functions. The memory 1250 may also store other software instructions (not shown), such as web video instructions to facilitate web video-related processes and functions; and/or web shopping instructions to facilitate web shopping-related processes and functions. In some implementations, the media processing instructions 1266 are divided into audio processing instructions and video processing instructions to facilitate audio processing-related processes and functions and video processing-related processes and functions, respectively. An activation record and International Mobile Equipment Identity (IMEI) 1274 or similar hardware identifier can also be stored in memory 1250.

Each of the above identified instructions and applications can correspond to a set of instructions for performing one or more functions described above. These instructions need not be implemented as separate software programs, procedures, or modules. The memory 1250 can include additional instructions or fewer instructions. Furthermore, various functions of the mobile device may be implemented in hardware and/or in software, including in one or more signal processing and/or application specific integrated circuits.

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal), that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code).

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the disclosed embodiments can be implemented on a computer having a display device, e.g., a CRT (cathode ray tube), LCD (liquid crystal display) monitor, touch sensitive device or display, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments have been described. Other embodiments are within the scope of the following claims.

What is claimed is:

1. A method comprising:
presenting a graphical user interface on a display device of an electronic device capable of receiving user input, the graphical user interface including a first menu with a set of mandatory operations, the set having a plurality of subsets;
creating a second menu including a selected subset of the mandatory operations in response to the subset of mandatory operations being removed from the first menu; and
modifying the graphical user interface to include the first menu with the mandatory operations except the removed subset and to include the second menu with having the subset of mandatory operations removed from the first menu.

2. The method of claim 1 wherein the subset of mandatory operations are removed in response to user-provided input.

3. The method of claim 1 further comprising adding the removed subset back to the first menu in response to second menu being removed.

4. The method of claim 3 wherein the second menu is removed in response to user-provided input.

5. A method for providing one or more pop-up menus in a graphical user interface of an electronic device, the menus including set of mandatory operations, the method comprising:
presenting all of the mandatory operations in a first pop-up menu in the graphical user interface;
receiving user-provided input indicating removal of a subset of the mandatory operations from the first pop-up menu;
generating a second pop-up menu that includes the subset of mandatory operations automatically in response to receiving the user-provided input; and
displaying first pop-up menu and the second pop-up menu in the graphical user interface, wherein the subset of mandatory operations is included in the second pop-up menu and not in the first pop-up menu.

6. The method of claim 5, wherein the set of mandatory operations comprise a plurality of predefined subsets of operations.

7. The method of claim 5 further comprising:
receiving user-provided input indicating removal of the second pop-up menu;
modifying the first pop-up menu to include the subset of mandatory operations; and
displaying the first pop-up menu in the graphical user interface and not displaying the second pop-up menu in the graphical user interface, wherein the first pop-up menu includes the subset of mandatory operations previously included in the second pop-up menu.

8. An apparatus comprising:
means for presenting a graphical user interface on a display device of an electronic device capable of receiving user input, the graphical user interface including a first menu with a set of mandatory operations, the set having a plurality of subsets;
means for creating a second menu including a selected subset of the mandatory operations in response to the subset of mandatory operations being removed from the first menu; and
means for modifying the graphical user interface to include the first menu with the mandatory operations except the removed subset and to include the second menu with having the subset of mandatory operations removed from the first menu.

9. The apparatus of claim 8 further comprising means for adding the removed subset back to the first menu in response to second menu being removed.

10. An apparatus for providing one or more pop-up menus in a graphical user interface of an electronic device, the menus including set of mandatory operations, the apparatus comprising:
means for presenting all of the mandatory operations in a first pop-up menu in the graphical user interface;
means for receiving user-provided input indicating removal of a subset of the mandatory operations from the first pop-up menu;
means for generating a second pop-up menu that includes the subset of mandatory operations automatically in response to receiving the user-provided input; and
means for displaying first pop-up menu and the second pop-up menu in the graphical user interface, wherein the subset of mandatory operations is included in the second pop-up menu and not in the first pop-up menu.

11. The apparatus of claim 10 further comprising:
means for receiving user-provided input indicating removal of the second pop-up menu;
means for modifying the first pop-up menu to include the subset of mandatory operations; and
means for displaying the first pop-up menu in the graphical user interface and not displaying the second pop-up menu in the graphical user interface, wherein the first pop-up menu includes the subset of mandatory operations previously included in the second pop-up menu.

12. An article of manufacture comprising a computer readable medium having stored thereon instructions that, when executed by one or more processors, cause the one or more processors to:
present a graphical user interface on a display device of an electronic device capable of receiving user input, the graphical user interface including a first menu with a set of mandatory operations, the set having a plurality of subsets;
create a second menu including a selected subset of the mandatory operations in response to the subset of mandatory operations being removed from the first menu; and
modify the graphical user interface to include the first menu with the mandatory operations except the removed subset and to include the second menu with having the subset of mandatory operations removed from the first menu.

13. The article of manufacture of claim 12 wherein the subset of mandatory operations are removed in response to user-provided input.

14. The article of manufacture of claim 12 further comprising instructions that, when executed, cause the one or more processors to add the removed subset back to the first menu in response to second menu being removed.

15. The article of manufacture of claim 14 wherein the second menu is removed in response to user-provided input.

16. An article of manufacture comprising a computer-readable medium having stored thereon instructions for providing one or more pop-up menus in a graphical user interface of an electronic device, the menus including set of mandatory operations, the instructions to cause one or more processors to:
present all of the mandatory operations in a first pop-up menu in the graphical user interface;
receive user-provided input indicating removal of a subset of the mandatory operations from the first pop-up menu;
generate a second pop-up menu that includes the subset of mandatory operations automatically in response to receiving the user-provided input; and
display first pop-up menu and the second pop-up menu in the graphical user interface, wherein the subset of mandatory operations is included in the second pop-up menu and not in the first pop-up menu.

17. The article of manufacture of claim 16 further comprising instructions that cause the one or more processors to:
receive user-provided input indicating removal of the second pop-up menu;
modify the first pop-up menu to include the subset of mandatory operations; and
display the first pop-up menu in the graphical user interface and not displaying the second pop-up menu in the graphical user interface, wherein the first pop-up menu includes the subset of mandatory operations previously included in the second pop-up menu.
